(19) United States
(12) Patent Application Publication
(10) Pub. No.: US 2016/0274391 A1
(43) Pub. Date: Sep. 22, 2016

(54) FLEXIBLE DISPLAY DEVICE AND MANUFACTURING METHOD THEREOF

(71) Applicant: Electronics and Telecommunications Research Institute, Daejeon (KR)

(72) Inventors: Chan Mo KANG, Daejeon (KR); Lee Mi DO, Daejeon (KR); Jin Hwa RYU, Daejeon (KR); Kyu Ha BAEK, Daejeon (KR)

(21) Appl. No.: 14/823,336

(22) Filed: Aug. 11, 2015

(30) Foreign Application Priority Data
Mar. 16, 2015 (KR) 10-2015-0035937

(51) Int. Cl. G02F 1/1341; G02F 1/1333; G02F 1/1337; G02F 1/1339

(52) U.S. Cl. CPC G02F 1/1341; G02F 1/13394; G02F 1/133305; G02F 1/133707; G02F 2001/13398

(57) ABSTRACT

Provided herein is a flexible display device including a lower substrate; spacers formed on the lower substrate; an adhesive deposited on the spacers; a display material filled in between the spacers; and an upper substrate adhered to the lower substrate by the adhesive.

### CROSS-REFERENCE TO RELATED APPLICATION

The present application claims priority to Korean patent application number 10-2015-0035937, filed on Mar. 16, 2015, the entire disclosure of which is incorporated herein in its entirety by reference.

### BACKGROUND

1. Field of Invention

Various embodiments of the present disclosure relate to a display device and a manufacturing method thereof, and more particularly, to a flexible display device and a manufacturing method thereof.

2. Description of Related Art

A flexible display is light, unbreakable, foldable, and bendable. Due to these characteristics, a flexible display is portable, and is taking the limelight as a next generation display.

A flexible display film is manufactured by arranging two flexible substrates each having an electrode, such that they face each other and are distanced from each other by a certain gap, and then injecting a display material in between the two flexible substrates. Herein, the display material should be prevented from dripping by bonding the edges or by forming a micro-cup array structure.

In order to manufacture such a flexible display film, there is needed a technique for maintaining a certain distance between the two substrates, a technique for manufacturing an orientation film for adjusting orientation of liquid crystal in a case where the display material is liquid crystal, and a sealing technique for preventing the display material having liquidity from dripping.

In general, a method for manufacturing a liquid crystal display device wherein a glass substrate is used is proceeded by forming an orientation film on the glass substrate where a conductive material is deposited, followed by dispersing a spacer and then sealing all edges except for a hole through which liquid crystal may be injected, followed by injecting the liquid crystal and then sealing the hole. However, when the aforementioned method is applied to a roll-to-roll process which is a manufacturing process of a flexible film, at the step of sealing the edges after dispersing the spacer, cutting may be conducted and then proceed to subsequent processes, thereby breaking continuity and thus reducing productivity.

In order to resolve this, Korean Patent Application no. 10-2011-0093482 suggests forming a bank at both edges along a longitudinal direction, and dropping a sealing agent between the banks so as to harden the same. However, in such a case, when a liquid crystal film is cut, the cut surface is not sealed, and thus there is needed an additional sealing process after the cutting, thereby increasing the procedures and cost. Furthermore, in this case as well, only the edges of the flexible film would be bonded, leaving the central portion unbonded, making it difficult to manufacture a large area flexible film.

Besides the above, there is a method of manufacturing a square partition and then filling the partition with a display material, and then sealing the partition by placing an upper plate thereon. Korean Patent Registration no. 10-0859305 suggests sealing the display material by depositing a UV hardening complex polymer on the display material as a method of boning the upper plate and lower plate. However, since the display material and UV hardening material are both liquid, they may blend with each other, deteriorating the characteristics of the display, and since the two materials must be subjected to phase separation using the density difference, there may be limited selection of materials.

### SUMMARY

Therefore, a purpose of various embodiments of the present disclosure is to provide a display device wherein manufacturing costs have been reduced and the characteristics of the display have been prevented from deterioration, and a manufacturing method thereof.

An embodiment of the present disclosure provides a flexible display device including a lower substrate; spacers formed on the lower substrate; an adhesive deposited on the spacers; a display material filled in between the spacers; and an upper substrate adhered to the lower substrate by the adhesive.

An embodiment of the present disclosure provides a manufacturing method of a flexible display device, the method including supplying a lower substrate from a first supply roll; passing the lower substrate between spacer rollers to form spacers on the lower substrate; passing the lower substrate between adhesive depositing rollers to selectively deposit an adhesive on an upper surface of the spacers; depositing a display material on the lower substrate exposed between the spacers; supplying an upper substrate from a second supply roll; and passing the lower substrate and upper substrate between adhesive rollers to adhere the lower substrate and upper substrate.

When adhering the flexible display, the adhesive is deposited only on the upper surface of the spacer so as to adhere the upper substrate and lower substrate. Therefore, it is possible to maintain a uniform gap, and reduce consumption of the adhesive material. Furthermore, since the display portion is prevented from being contaminated by the adhesive material and thus from becoming murky, it is possible to increase the screen quality of the display.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a view for explaining a method for manufacturing a flexible display device according to an embodiment of the present disclosure;

FIGS. 2A to 2D are perspective views of spacer rollers that may be used in a method for manufacturing a flexible display device according to an embodiment of the present disclosure;

FIGS. 3A to FIG. 6A and FIGS. 3B to 6B illustrate different states of a display device according to an embodiment of the present disclosure, FIGS. 3A, 4A, 5A, and 6A being plane views, and FIGS. 3B, 4B, 5B, and 6B being side views.

FIGS. 7A to 9A and FIGS. 7B to FIG. 9B illustrate various second convex and concave structures formed on a first protruding unit of a spacer roller according to an embodiment of the present disclosure, FIGS. 7A, 8A, and 9A illustrating spacer rollers, and FIGS. 7B, 8B, and 9B being cross-sectional views of a spacer roller.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

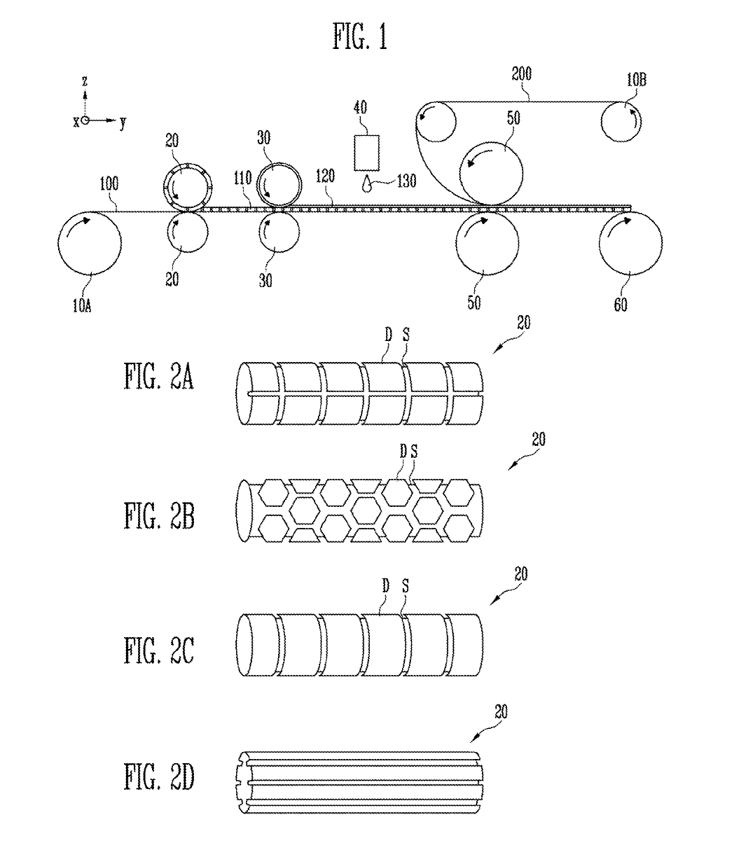

FIG. 1 is a view for explaining a method for manufacturing a flexible display device according to an embodiment of the present disclosure. It is a view schematically illustrating a method for manufacturing a flexible display device using a roll-to-roll process.

Referring to FIG. 1, a lower substrate 100 is supplied from a first supply roll 10A. Herein, the lower substrate 100 may be a flexible plastic substrate having a light transmission function. For example, the lower substrate 100 may include polyvinyl chloride resin, vinyl acetate resin, polystyrene resin, polyamide resin, polyimide resin, methacrylic resin, melamine resin, polyurethane resin, polyethylene resin, ethylene vinyl copolymer resin, polypropylene resin, polyester resin, acrylic resin, nylon, polycarbonate resin, or cellulose resin.

Furthermore, a conductive material may be deposited on the lower substrate 100. For example, the conductive material may include a TCO (transparent conducting oxide) material such as ITO (indium tin oxide), IZO (indium tin oxide) and FTO (fluorine doped tin oxide), or CNT (carbon nanotube), graphene, conductive polymer, metal nanowire, and thin metal film and the like.

Then, the supplied lower substrate 100 is passed through spacer rollers 20, and thus spacers 110 are formed on the lower substrate 100. Herein, the spacers 110 are formed such that a display area of a polygonal shape, closed curve, and line and the like is defined. The spacers 110 are formed to have a flat upper surface and a uniform height, such that an adhesive 120 is deposited uniformly. Furthermore, on the upper surfaces of the spacers 21, patterns may be formed such that the adhesive may be easily adhered to. For example, on the upper surface of the spacer 21, a pattern such as a line, pyramid, cone, cylinder, polypyramid, polyprism, hook, or needle and the like may be formed.

Then, between the adhesive depositing rollers 30, the lower substrate 100 where the spacer 110 is formed is passed through. By doing this, the adhesive 120 is deposited only on the upper surface of the spacer 110. Herein, the process of depositing the adhesive 120 may be an offset printing, gravure printing, gravure offset printing, flexo printing, reverse offset printing, imprinting, contact printing, or rotary screen printing method and the like.

Then, by a display material depositing device 40, a display material 130 is deposited on the lower substrate 100 exposed between the spacers 110. By doing this, the display material 130 is deposited on the display area defined between the spacers 110.

Herein, the display material 41 may include an SPD (suspended particle display) material, liquid crystal, electrophoretic material, or electrolyte material. Furthermore, at the step of depositing the display material, a slot-die coating, pipetting coating, blade coating, bar coating, rod coating, roll coating, spray coating, dispensing, stamping, imprinting, inkjet printing, or nozzle printing and the like may be used.

Then, from a second supply roll 10B, an upper substrate 200 is supplied. Herein, the upper substrate 200 may be a flexible plastic substrate having a light transmission function. For example, the upper substrate 200 may include polyvinyl chloride resin, vinyl acetate resin, polystyrene resin, polyamide resin, polyimide resin, methacrylic resin, melamine resin, polyurethane resin, polyethylene resin, ethylene vinyl copolymer resin, polypropylene resin, polyester resin, acrylic resin, nylon, polycarbonate resin, or cellulose resin and the like.

Furthermore, on the upper substrate 200, a conductive material may be deposited. For example, the conductive material may include a TCO (transparent conducting oxide) material such as ITO (indium tin oxide), IZO (indium tin oxide) and FTO (fluorine doped tin oxide), or CNT (carbon nanotube), graphene, conductive polymer, metal nanowire, and thin metal film and the like.

Then, between adhesive rollers 50, the lower substrate 100 and upper substrate 200 are passed through. Herein, by the adhesive 120 deposited only on the upper surface of the spacer 110, the lower substrate 100 and upper substrate 200 are adhered. Herein, in the adhering process, heat, pressure or UV light may be used. Then, the adhered substrates are wound around a withdrawing roll 60.

According to the aforementioned process, the adhesive may be deposited selectively only on the upper surface of the spacer using the adhesive deposited roller 30. Therefore, by reducing the usage of the adhesive, it is possible to reduce the manufacturing cost. Furthermore, it is possible to prevent the display area from being contaminated by the adhesive, thereby increasing the transmittance of the display area, and improving the screen quality of the display device.

FIGS. 2A to 2D are perspective views of spacer rollers that may be used in a method for manufacturing a flexible display device according to an embodiment of the present disclosure.

Referring to FIGS. 2A to 2D, the main body of the spacer roller 20 is cylindrical, and its surface has first convex and concave structure structures. Herein, the purpose of the first convex and concave structures is to define a display area D and a spacer area S. For example, the spacer roller 20 includes the first protruding unit configured to define the display area D, and a first groove unit configured to define the spacer area S.

The spacer roller 20 may include the first convex and concave structures of various shapes. Referring to FIGS. 2A and 2B, the first protruding unit may be one of various shapes such as a square and hexagon. Referring to FIGS. 2C and 2D, the first protruding unit may have a line shape, the line shape expanding in a width direction of the spacer roller 20, or expanding in a length direction of the spacer roller 20.

Herein, a width, height, and length of the spacer 110 shown in FIG. 1 may be adjusted suitably by the designer. Furthermore, in a case where the display material 130 shown in FIG. 1 is liquid crystal, for orientation of the liquid crystal, the spacer roller 20 may have additional second convex and concave structures. For example, the additional second convex and concave structures may be formed in a straight line, corrugation shape, zig-zag shape, polyprism shape, polypyramid shape, cylinder shape, and cone shape and the like. The second convex and concave structures for liquid crystal orientation will be explained in detail hereinafter with reference to FIGS. 7A to 9A and 7B to 9B.

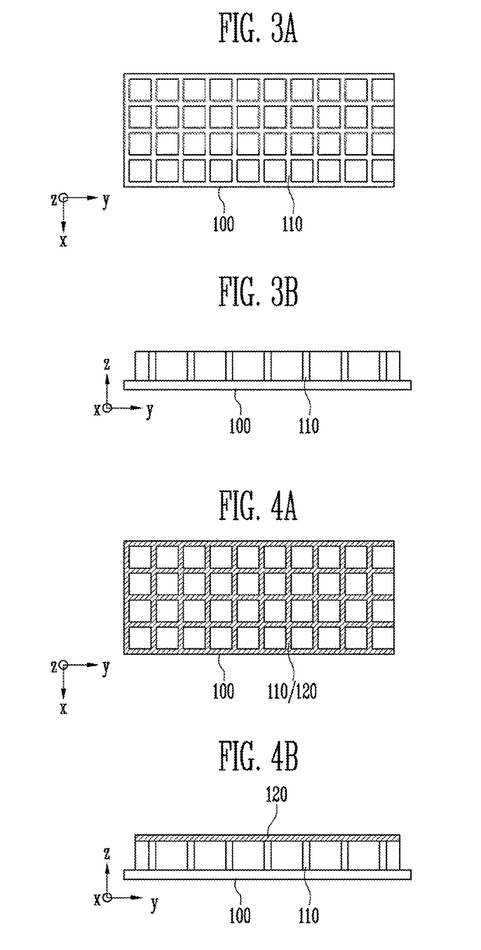

FIGS. 3A to 6A and 3B to 6B illustrate different states of a display device according to an embodiment of the present disclosure, FIGS. 3A, 4A, 5A, and 6A being plane views, and FIGS. 3B, 4B, 5B, and 6B being side views.

FIGS. 3A and 3B illustrate the lower substrate 100 where the spacer 110 is formed after passing through the spacer roller 20. By the spacer roller 20, the spacer 110 of a line or closed curve may be formed, and the present embodiment represents a case where the spacer 110 is formed that defines a square display area.

FIGS. 4A and 4B illustrate the lower substrate 100 that passed through the adhesive depositing roller 30. By the adhesive depositing roller 30, the adhesive 120 is selectively deposited only on the upper surface of the spacer 110.

FIGS. 5A and 5B illustrate a state where the display material 130 is deposited on the lower substrate 110 exposed between the spacer 110. Herein, by the display material depositing device 40, the display material 130 is deposited only on the display area excluding the spacer 110.

FIGS. 6A and 6B illustrate the upper substrate 200 and lower substrate 100 adhered after passing through the adhesive roller 50. Herein, for the adhesion, heat, pressure, or UV light may be used.

FIGS. 7A to 9A and 7B to 9B illustrate various second convex and concave structures formed on the first protruding unit of the spacer roller according to an embodiment of the present disclosure, FIGS. 7A, 8A, and 9A illustrating the spacer roller, and FIGS. 7B, 8B, and 9B illustrating cross-sections of the spacer roller cut along line “I-I”.

Referring to FIGS. 7A to 9A and 7B to 9B, the second convex and concave structures are formed on the first protruding unit defined as display area D. The second convex and concave structures may be formed for liquid crystal orientation. The second convex and concave structures may include a second protruding unit (p1 to p3) and second groove unit (c1 to c3). The second groove unit (c1 to c3) may be formed more minutely than a first groove unit defined as spacer area S.

The second protruding unit (p1 to p3) and second groove unit (c1 to c3) may be formed in various structures such as a corrugated shape, zig-zag shape, polyprism shape, polypyramid shape, cylinder shape, and cone pattern.

For example, as illustrated in FIGS. 7A and 7B, the second protruding unit (p1) and second groove unit (c1) may be formed in a straight line form along the first protruding unit of the spacer roller. The second protruding unit (p1) and second groove unit (c1) may have a square cross-section.

Furthermore, as illustrated in FIGS. 8A and 8B, the second protruding unit (p2) and second groove unit (c2) may be formed in a straight line form along the first protruding unit of the spacer roller. The second protruding unit (p2) and second groove unit (c2) may have a triangular cross-section.

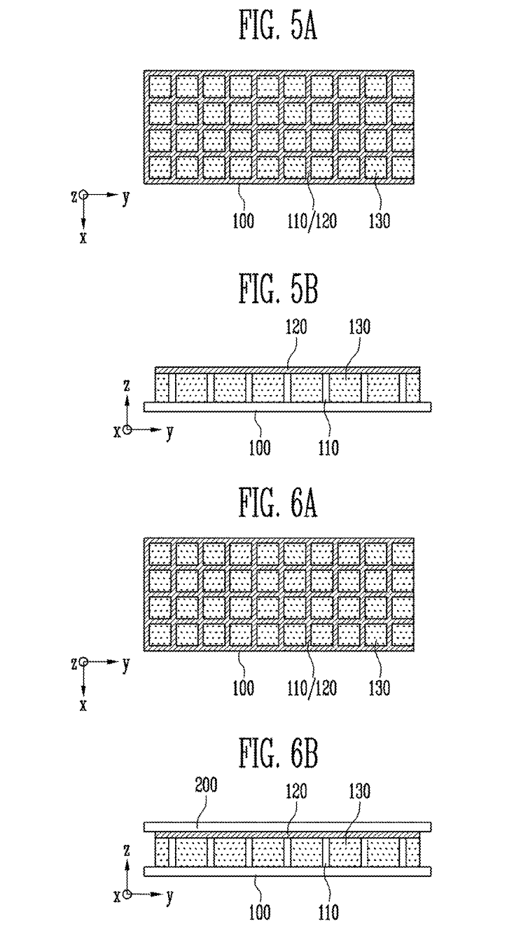

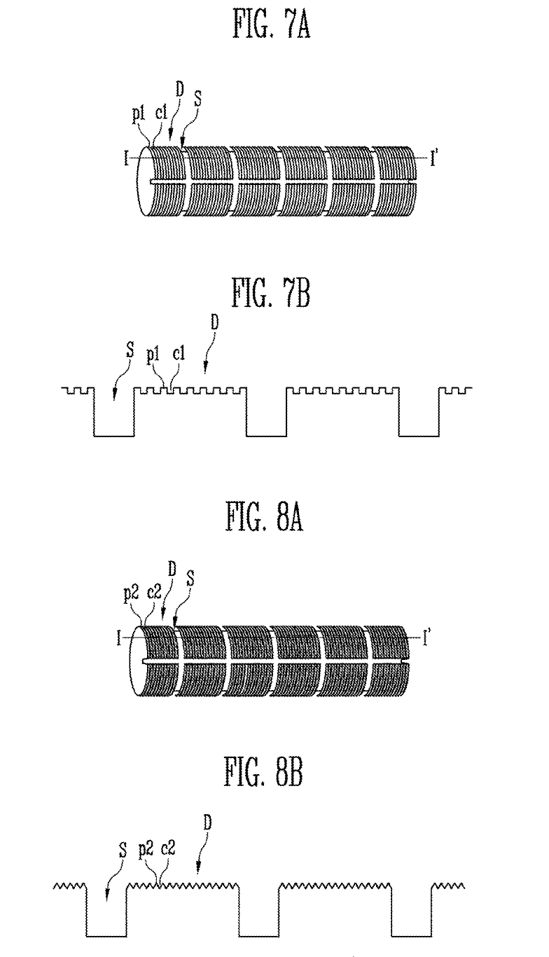

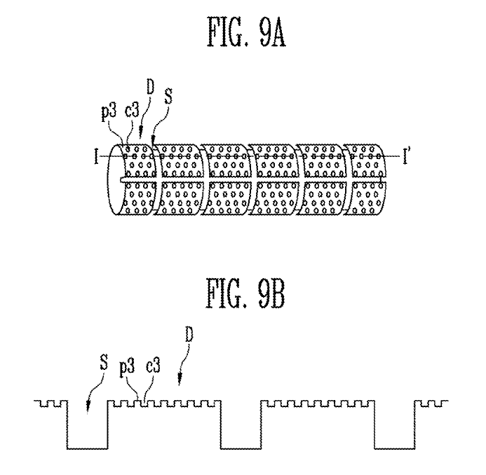

Furthermore, as illustrated in FIGS. 9A and 9B, the second groove unit (c3) may be formed in a circular shape on the first protruding unit of the spacer roller.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A flexible display device comprising:
a lower substrate;
spacers formed on the lower substrate;
an adhesive deposited on the spacers;
a display material filled in between the spacers; and
an upper substrate adhered to the lower substrate by the adhesive.

2. The flexible display device according to claim 1,
wherein the lower substrate and upper substrate are flexible plastic substrates having a light transmission function.

3. The flexible display device according to claim 2,
wherein the lower substrate and upper substrate comprises polyvinyl chloride resin, vinyl acetate resin, polystyrene resin, polyamide resin, polyimide resin, methacrylic resin, melamine resin, polyurethane resin, polyethylene resin, ethylene vinyl copolymer resin, polypropylene resin, polyester resin, acrylic resin, nylon, polycarbonate resin, or cellulose resin.

4. The flexible display device according to claim 1,
wherein the display material comprises an SPD (suspended particle display) material, liquid crystal material, electrophoretic material or electrolyte.

5. The flexible display device according to claim 1,
wherein the spacers have a uniform height.

6. The flexible display device according to claim 1,
wherein the spacers have a flat upper surface.

7. A manufacturing method of a flexible display device, the method comprising:
supplying a lower substrate from a first supply roll;
passing the lower substrate between spacer rollers to form spacers on the lower substrate;
passing the lower substrate between adhesive depositing rollers to selectively deposit an adhesive on an upper surface of the spacers;
depositing a display material on the lower substrate exposed between the spacers;
supplying an upper substrate from a second supply roll; and
passing the lower substrate and upper substrate between adhesive rollers to adhere the lower substrate and upper substrate.

8. The manufacturing method according to claim 7,
wherein the depositing an adhesive uses an offset printing, gravure printing, gravure offset printing, flexo printing, reverse offset printing, imprinting, contact printing, or rotary screen printing method.

9. The manufacturing method according to claim 7,
wherein the depositing a display material uses a slot-die coating, pipetting coating, blade coating, bar coating, rod coating, roll coating, spray coating, dispensing, stamping, imprinting, inkjet printing, or nozzle printing.

10. The manufacturing method according to claim 7,
wherein the adhering the lower substrate and upper substrate uses heat, pressure or UV light.

11. The manufacturing method according to claim 7,
wherein the spacer roller has first convex and concave structures including a first groove unit for defining a spacer area and a first protruding unit for defining a display area.

12. The manufacturing method according to claim 11,
wherein the first protruding unit has a polygonal, closed curve or line shape.

13. The manufacturing method according to claim 11,
wherein the first protruding unit has second convex and concave structures for orientation of liquid crystal.

14. The manufacturing method according to claim 13,
wherein the second convex and concave structures comprise a second protruding unit or second groove unit of a straight line shape, corrugation shape, zig- zag shape, polyprism shape, polypyramid shape, cylinder shape, or cone pattern.
